(19) United States
(12) Patent Application Publication
(10) Pub. No.: US 2015/0243259 A1
(43) Pub. Date: Aug. 27, 2015

(54) METHOD AND APPARATUS FOR TRANSFERRING DATA IN A COMPUTER

(71) Applicant: NATIONAL TSING HUA UNIVERSITY, HSINCHU (TW)

(72) Inventors: CHIA CHEN HSU, CHANGHUA COUNTY (TW); SHIN KAI CHEN, KAOHSIUNG CITY (TW); CHENG YEN LIN, HSINCHU (TW); CHIH WEI LIU, HSINCHU CITY (TW); JENQ KUEN LEE, HSINCHU (TW)

(73) Assignee: NATIONAL TSING HUA UNIVERSITY, HSINCHU (TW)

(21) Appl. No.: 14/190,655

(22) Filed: Feb. 26, 2014

(51) Int. Cl. G09G 5/39; G06T 1/60

(52) U.S. Cl. CPC G09G 5/39; G06T 1/60

(57) ABSTRACT

A transpose unit of an apparatus comprises a plurality of banks each having a plurality of storage units, a write circuit, a plurality of selectors, and a parallel-to-serial circuit. The write circuit is configured to perform selections on the plurality of banks for storing data from a source memory. Each selector comprises an output and a plurality of inputs respectively coupled with the plurality of storage units of a corresponding bank, and the outputs of the plurality of selectors connect in parallel with the parallel-to-serial circuit. The parallel-to-serial circuit has a serial output connecting to a destination memory.

### BACKGROUND OF THE INVENTION

1. Field of the Invention

The present invention relates to a method and apparatus for transferring data in a computer, and in particular to a method and apparatus for transferring data between a memory for a central processing unit (CPU) and a memory for a graphics processing unit (GPU).

2. Description of the Related Art

A system having heterogeneous parallel computing power may use different types of processors. The different types of processors may be designed with different architectures so that they may prefer different data layouts. A representative example of such a system usually seen today is a CPU-GPU system.

Data layouts may include SoA (structure of array) and AoS (array of structure). Usually, the SoA approach is suitable for GPUs and the AoS approach is suitable for conventional CPUs. When a GPU processes data in the AoS layout, coalescing issues may occur. In order to achieve coalesced memory access and high memory performance, the data needs to be transformed from the AoS layout to the SoA layout before it is processed by a GPU. Similarly, when a CPU processes data in the SoA layout, the CPU needs to gather data in different memory locations, which would result in discrete memory access issues. Therefore, the data should be transformed from the SoA layout to the AoS layout before it is processed by the CPU.

Currently, the transformation of data from the SoA layout to the AoS layout, or vice versa, is by means of software, but it is insufficient and causes a burden to the CPU-GPU system.

### SUMMARY OF THE INVENTION

In one embodiment of the present invention, an apparatus for transferring data in a computer comprises a transpose unit. The transpose unit comprises a plurality of banks, a write circuit, a plurality of selectors, and a parallel-to-serial circuit. Each bank has a plurality of storage units. The write circuit is coupled with each bank and a source memory. The write circuit is configured to perform selections on the plurality of banks for storing data from the source memory. The plurality of selectors correspond to the plurality of banks. Each selector comprises an output and a plurality of inputs respectively coupled with the plurality of storage units of the corresponding bank. The parallel-to-serial circuit is coupled with the plurality of selectors and a destination memory. The outputs of the plurality of selectors connect in parallel with the parallel-to-serial circuit.

In one embodiment of the present invention, a method for transferring data in a computer is disclosed. The method comprises providing data in a source memory, wherein the data is formed by a plurality of data segments corresponding to each other and each data segment comprises a plurality of data elements; simultaneously retrieving one data element from each data segment; converting the retrieved data elements into a serial data stream; and transferring the serial data stream to a destination memory.

### BRIEF DESCRIPTION OF THE DRAWINGS

The objectives and advantages of the present invention will become apparent upon reading the following description and upon referring to the accompanying drawings in which:

FIG. 1 schematically shows an apparatus for transferring data in a computer according to one embodiment of the present invention;

FIG. 2 is a state diagram for an apparatus for transferring data in a computer according to one embodiment of the present invention;

FIG. 3 schematically shows a transpose unit according to one embodiment of the present invention;

FIG. 4A is a host code for an apparatus for transferring data in a computer 1 according to one embodiment of the present invention;

FIG. 4B schematically shows a process of running a host code on the apparatus according to one embodiment of the present invention; and

FIG. 5 shows an out-of-order data flow in an apparatus 2 according to one embodiment of the present invention.

### DETAILED DESCRIPTION OF THE INVENTION

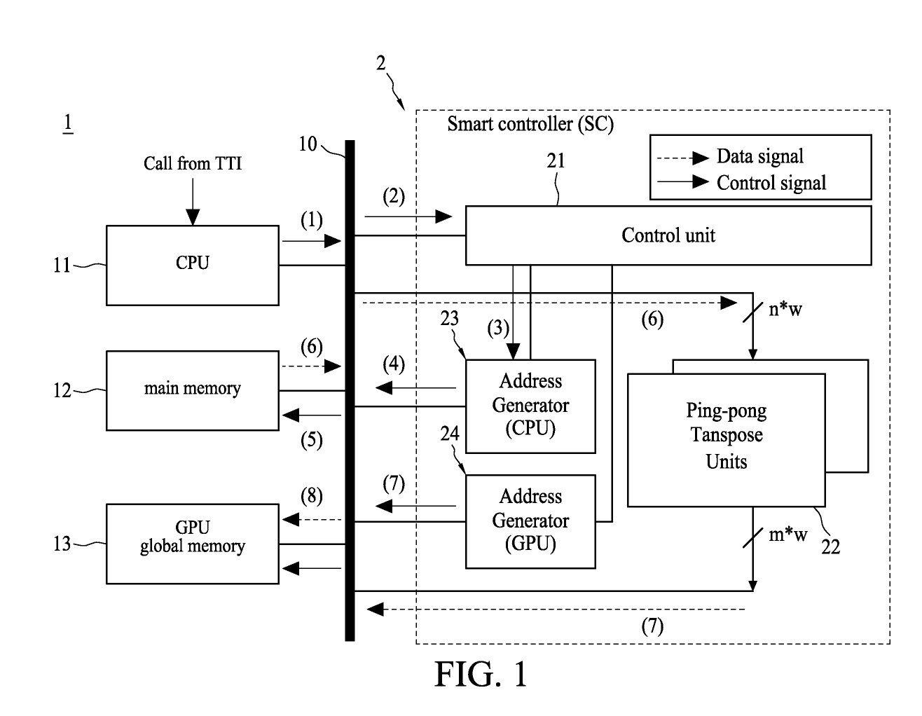

FIG. 1 schematically shows an apparatus 2 for transferring data in a computer 1 according to one embodiment of the present invention. FIG. 1 shows control and data signals respectively indicated in sequence by numbers from (1) to (8). Referring to FIG. 1, a computer 1 comprises at least one CPU (central processing unit) 11 connecting to a system bus 10, a source or main memory 12 connecting to the system bus 10 and closely interacting with the CPU 11, a destination or GPU global memory 13 connecting to the system bus 10 and used by at least one GPU (graphics processing unit), and an apparatus or smart controller (SC) 2 connecting to the system bus 10 and configured to transfer data between the main memory 12 and the GPU global memory 13. In one embodiment, the apparatus 2 is configured as a master IP (a master instruction processor) or a smart controller.

Referring to FIG. 1, the apparatus 2 is configured to transfer data between the main memory 12 and the GPU global memory 13 with simultaneous conversion of the data to a suitable layout for either the CPU 11 or the GPU. The apparatus 2 comprises a control unit 21 coupled with the system bus 10, at least one transpose unit (TU) 22 coupled with the control unit 21 and the system bus 10, a CPU address generator 23 coupled with the system bus 10 and the control unit 21, and a GPU address generator 24 coupled with the control unit 21 and the system bus 10.

The control unit 21 is configured to control the at least one transpose unit 22 and two address generators 23 and 24, and to communicate with the CPU 11 to receive a signal for initializing the transferring of data between the main memory 12 and the GPU global memory 13. When the CPU 11 gets a call from an API (Application Programming Interface), the CPU 11 sends a signal to the control unit 21 through the system bus 10, and the control unit 21 accordingly begins transferring data. The CPU 11 may continue the next job without waiting for the transfer completion. The CPU 11 may not wait for the completion of data transfer according to a non-blocking instruction. The CPU 11 may wait for a completion signal from the control unit 21 for executing an instruction needing the transferred data.

In one embodiment, the control unit 21 is configured to send a signal to the CPU 11 or GPU when the transfer of data is completed.

In one embodiment, after the apparatus 2 receives a data-transfer signal from the CPU 11, the apparatus 2 schedules the memory access and/or transpose operations on scalable data sets in a pipelined manner.

The transpose unit 22 is configured to convert the layout of data from AoS (Array of Structure) to SoA (Structure of Array), or vice versa. Although the embodiment of FIG. 1 demonstrates the conversion of AoS to SoA, the present invention is not limited to such.

The transpose unit 22 may be designed to transpose data of a predetermined size (n, m). The predetermined size (n, m) can be determined based on the memory bandwidths at which data is read from or stored into the main memory 12 by the CPU 11, and read from or stored into the GPU global memory 13 by the GPU. In one embodiment, supposing that the CPU memory bandwidth is c bytes, the GPU global memory bandwidth is g bytes, and the element of data has a width of w bytes, the following relationship can be obtained:

(n×w, m×w)=(g, c)

In one embodiment, the apparatus 2 has only one transpose unit 22.

In another embodiment, the apparatus 2 can have two transpose units 22. The control unit 21 can determine whether to use one or two transpose units 22 according to the size (A, S) of the source data to be transferred, wherein A is the array size of the source data and S is the structure size of the source data. If the size (A, S) of the source data satisfies the following conditions (1) and (2), the control unit 21 uses one transpose unit 22 to transpose data; if the size (A, S) of the source data satisfies the following condition (3), the control unit 21 uses two transpose units 22 to transpose data.

(A,S)=(n, m) (1)

(A,S)=(sn, sm) where 0<sn×sm<n×m (2)

(A,S)=(ln, lm) where ln×lm>n×n×m (3)

In one embodiment, the control unit 21 uses two transpose units 22, and the two transpose units 22 are operated in a ping-pong like manner.

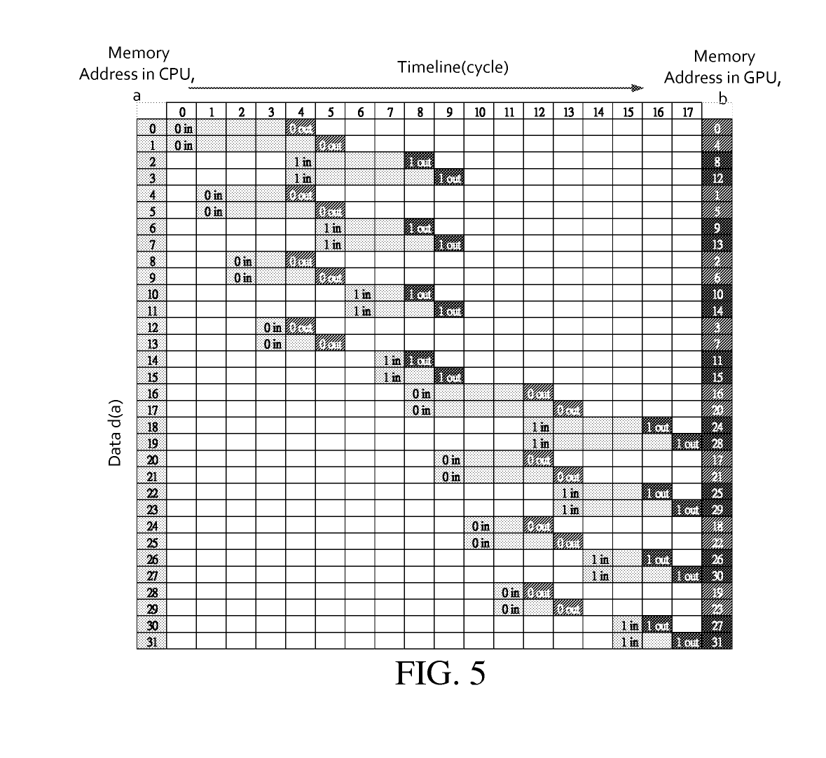

In one embodiment, the control unit 21 is configured to control the transpose unit 22 to transfer data by an out-of-order manner, as shown in FIG. 5, in order to prevent the transpose unit 22 from stalling when data is moved in and out of the transpose unit 22.

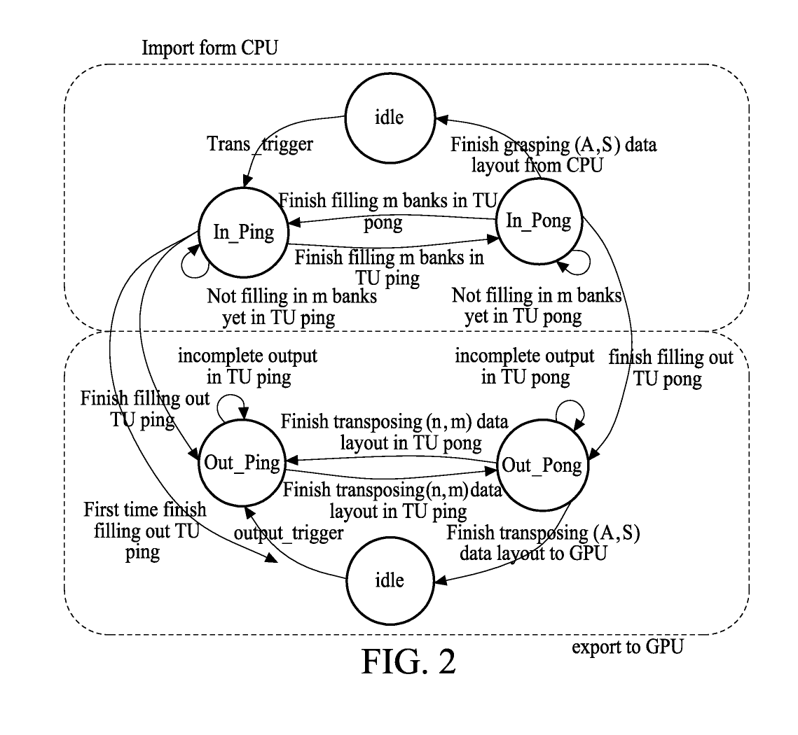

FIG. 2 is a state diagram for an apparatus 2 for transferring data in a computer according to one embodiment of the present invention. Referring to FIGS. 1 and 2, after the control unit 21 receives a signal (Trans_trigger) from the CPU 11, the apparatus 2 moves to a state In_Ping/In_Pong. In the In_Ping/In_Pong state, data is sent from the main memory 12 to the ping/pong transpose unit 22. The ping/pong transpose unit 22 continues receiving data until its storage capacity is exhausted or the ping/pong transpose unit 22 receives a predetermined amount of data. When the ping transpose unit 22 is full, the state changes to the In_Pong state or the Out_Ping state; when the pong transpose unit 22 is full, the state changes to the In_Ping state or the Out_Pong state. In the Out_Ping/Out_Pong state, data stored in the ping/pong transpose unit 22 begins being moved to the GPU global memory 13.

Referring to FIGS. 1 and 2, before data is transferred from the main memory 12 to the ping/pong transpose unit 22, the control unit 21 controls the address generator 23 to send a load request to the controller of the main memory 12, and the address generator 23 (or the controller of the main memory 12) generates an address. After a read transaction is performed, the main memory 12 outputs a burst of data to the ping/pong transpose unit 22. Before data in the ping/pong transpose unit 22 is transferred to the GPU global memory 13, the control unit 21 controls the address generator 24 for the GPU to send a write request to the controller of the GPU global memory 13 and to generate an address for data outputted to the GPU global memory 13.

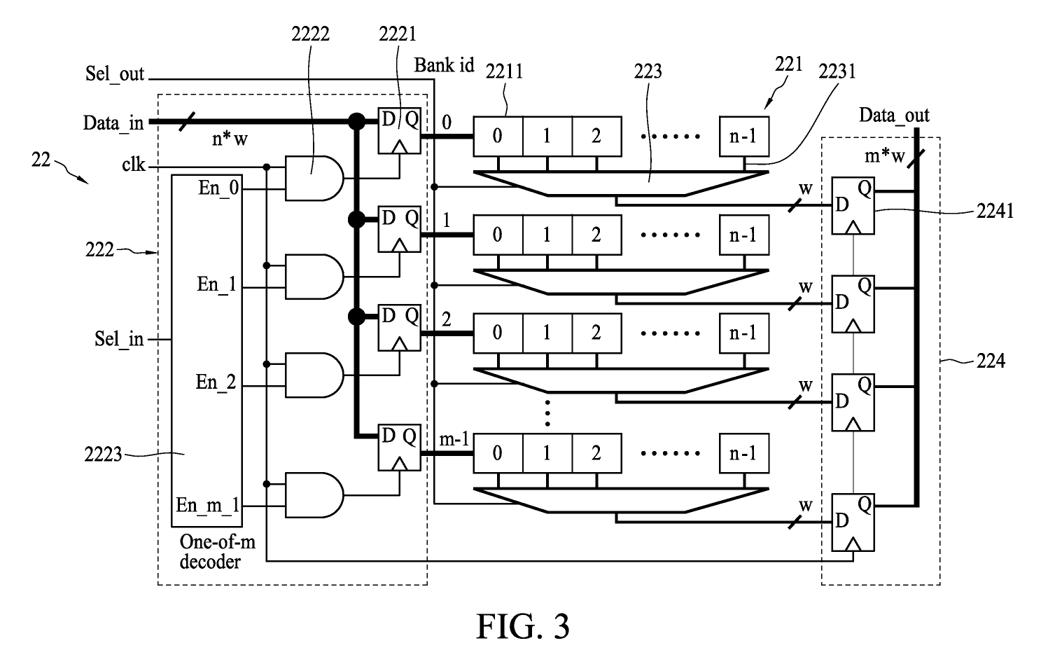

FIG. 3 schematically shows a transpose unit 22 according to one embodiment of the present invention. Referring to FIG. 3, the transpose unit 22 comprises a plurality of banks 221, a write circuit 222 coupled with each bank 221 and the source memory 12, a plurality of selectors 223 corresponding to the plurality of banks 221, and a parallel-to-serial circuit 224 coupled with the plurality of selectors 223 and the destination memory.

The write circuit 222 is configured to perform selections on the plurality of banks 221 for storing data from the main memory 12. The write circuit 222 can be controlled by the control unit 21. In one embodiment, the write circuit 222 selects one bank 221 at each clock cycle for storing data.

As shown in FIG. 3, in one embodiment, the write circuit 222 comprises a plurality of D flip-flops or latches 2221 corresponding to the plurality of banks 221, a plurality of AND gates 2222 corresponding to the plurality of D flip-flops 2221, and a decoder 2223. An output (Q) of each D flip-flop 2221 connects to a corresponding bank 221. A data input (D) of each D flip-flop 2221 connects to the main memory 12 for data input. A clock input of each D flip-flop 2221 connects to the output of a corresponding AND gate 2222. Each AND gate 2222 has one input connecting to a clock signal node (clk) and another input connecting to an output of the decoder 2223. The decoder 2223 has one input for receiving a Sel_in signal from the control unit 21, thereby selecting one bank 221 for allocation of input data or determining one bank 221 for allocation of input data at each clock cycle.

Each bank 221 may comprise a plurality of storage units 2211. The storage unit 2211 can store one data element of a plurality of sequentially arranged data elements of data in the main memory 12. In one embodiment, the element is one-byte data. In one embodiment, the number of the plurality of storage units 2211 is equivalent to the maximum number of the data elements that can be read from or stored into the main memory 12 by the CPU 11.

Moreover, each selector 223 comprises a plurality of inputs 2231 that are respectively coupled with the plurality of storage units 2211 of the corresponding bank 221. The selector 223 is configured to individually output the data elements stored in the plurality of storage units 2211 of the corresponding bank 221.

Each selector 223 has an output, and the outputs of the plurality of selectors 223 connect in parallel with the parallel-to-serial circuit 224. The control unit 21 sends a Sel_out signal to each selector 223 when the transpose unit 22 is ready for outputting data, or when it is full. After each selector 223 receives the Sel_out signal, a one w-byte vector or data element is outputted and m×w -byte data (or m's data elements) is generated. When the parallel-to-serial circuit 224 receives the data elements outputted from the plurality of selectors 223, the parallel-to-serial circuit 224 converts the data elements received in parallel into a serial data stream, which is then sent to the GPU global memory 13 via a serial output of the parallel-to-serial circuit 224.

In one embodiment, the selector 223 is a multiplexer. In one embodiment, at each cycle, after each selector 223 receives the Sel_out signal, data elements in the storage units 2211 having the same index number are outputted.

Referring to FIG. 3, in one embodiment, the parallel-to-serial circuit 224 can be a shift register. In one embodiment, the parallel-to-serial circuit 224 comprises a plurality of latches or D flip-flops 2241 corresponding to the plurality of selectors 223. Each D flip-flop 2241 has a data input (D) connecting to the output of a corresponding selector 223, an output (Q) connecting to a wire connecting to the GPU global memory 13, and a clock input connecting to a clock signal node (clk).

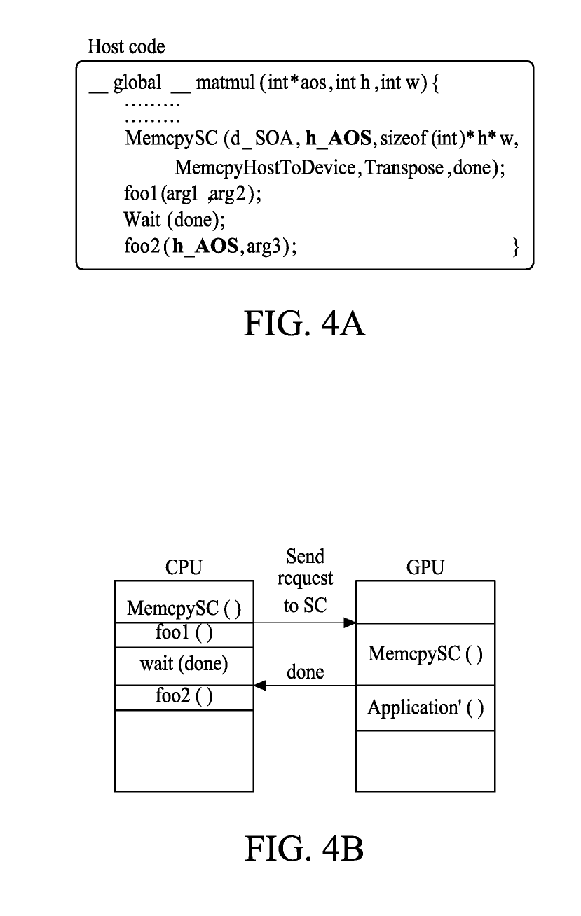

FIG. 4A is a host code for an apparatus 2 for transferring data in a computer 1 according to one embodiment of the present invention. FIG. 4B schematically shows a process of running the host code on the apparatus 2 according to one embodiment of the present invention. Referring to FIGS. 4A and 4B, CUDA is a NVIDIA's parallel computing architecture. Programs can use cudaMemcpy(void *dst, const void *src, size_t count, cudaMemcpyKind) to perform a memory copy operation. Compared with the cudaMemcpy API, the API, shown in FIG. 4A, additionally includes a Transpose argument. The Transpose argument can be assigned either normal or transpose. If the Transpose argument is assigned normal, the apparatus 2 transfers data from the main memory 12 to the GPU global memory 13 without performing a transposition operation; if the Transpose argument is assigned transpose, the apparatus 2 transposes data during transfer of the data. The apparatus 2 may support a non-blocking operation. After the transfer of data from the main memory 12 to the GPU global memory 13 is complete, the apparatus 2 will trigger a non-blocking signal to inform a source processor, which is the CPU in the present embodiment, that data transmission is complete.

Referring to FIGS. 4A and 4B, after the MemcpySC( ) is called, the API for the apparatus 2 sends a trigger signal (Trans_trigger) to the apparatus 2, and then the CPU 11 proceeds to execute the next instructions, foo1( )and foo2( ). The instruction foo2( )needs h_AOS, wait(done) to be employed in order to determine whether the data transfer is completed or not.

FIG. 5 shows an out-of-order data flow in an apparatus 2 according to one embodiment of the present invention. In FIG. 5, the apparatus 2 includes two transpose units (i.e., transpose unit₀ and transpose unit₁) each having in banks and n storage units of each bank, and a source data having a size (A=4, S=8), wherein d(a) represents the data stored in CPU memory address a, 0ᵢₙ represents that a storage unit of a bank of a transpose unit₀ is written with a data element, lᵢₙ represents that a storage unit of a bank of a transpose unit₁ is written with a data element, 0ₒᵤₜ represents that the data element stored in a storage unit of a bank of a transpose unit₀ is transferred out, lₒᵤₜ represents that the data element stored in a storage unit of a bank of a transpose unit₁ is transferred out, and grids having a light grey background indicate a storage unit of a bank of a transpose unit₀ or unit₁ is storing a data element.

Referring to FIG. 5, at cycle 0, the first data element (at address 0) and the following n-1 data element(s) (at address 1) are initially selected and outputted to a bank of a transpose unit₀ of the apparatus 2. At cycles 1 to 3, the data element (at address 4) of the number A^{th} from the first one (at address 0) of the last outputted data elements (at addresses 0 and 1) and the following n-1 data element(s) (at address 5) are selected and outputted to another bank of a transpose unit₀, and the process continues until all banks of the transpose unit₀ are full. At cycle 4, the first untransferred data element (at address 2) and the following n-1 data element(s) (at address 3) are transferred to a bank of another transpose unit₁, and at the same time, a data element (originally at address 0, 4, 8, 12 of the main memory) stored in a corresponding storage unit of each bank of the transpose unit₀ is transferred out and the four data elements are then converted into a serial signal stream in order to store in the GPU global memory. Thereafter, at cycle 5, another data element (originally at address 1, 5, 9 or 13) stored in another corresponding storage unit of each bank of the transpose unit₀ is transferred out, and simultaneously, the data element (at address 4) of the number A^{th} from the first one (at address 6) of the last transferred data elements (respectively at addresses 2 and 3) and the following n-1 data element(s) (at address 7) are transferred to another bank of the transpose unit₁, and the process is repeated at the following cycles until the banks of the transpose unit₁ are full. At cycles 8 to 17, all the above processes are repeated from the first two unselected data elements until all source data is transferred.

Alternatively, in one embodiment, the apparatus 2 can be employed to convert data when the data is being transferred from a GPU memory as a source memory to a CPU main memory as a destination memory. In another embodiment, the above-mentioned apparatus 2 is configured to bidirectionally transfer and convert data between a memory closely interacting with a CPU and a memory closely interacting with a GPU, and in such embodiment, a transpose unit (TU) 22 will have a number s of banks 221 and the bank 221 will have a number s of registers or storage units 2211, wherein s=min(n, m).

The present invention provides a method for transferring data in a computer. The method can be implemented on a hardware computer comprising a processor and a memory coupled with the processor. The method can be employed to transfer data in a main memory closely interacting with a central processing unit to a global GPU memory, or vice versa. The data is formed by a plurality of closely arranged data segments. The data segments correspond to each other; namely, the data segments have the same number of data elements, and the data elements of the data segments at the same corresponding position have a same type. In one embodiment, the data is in the AoS format. Each data segment is a structure and the plurality of data segments form an array.

In the embodiment of FIG. 5, because the array size is four, each data segment includes four data elements. For example, the first data segment includes data elements stored at memory addresses from 0 to 3.

The method then simultaneously retrieves one data element from each data segment to obtain a plurality of data elements arranged in parallel. Next, the method converts the retrieved data elements into a serial data stream and then sends the serial data stream to the global GPU.

In one embodiment, the method retrieves data elements from the same corresponding position of each data segment to generate the serial data stream.

In one embodiment, the data elements of each serial data stream have the same type.

In one embodiment, the method uses one transpose unit having a plurality of banks each having a plurality of storage units to store data elements. In one embodiment, data elements of each data segment are stored in a corresponding bank. In one embodiment, the method uses two transpose units to store data elements, and corresponding banks of the two transpose units store data elements of a data segment.

In one embodiment, as shown in FIG. 3, the method uses a write circuit 222 to write data elements to the banks of at least one transpose unit.

In one embodiment, the method uses a selector 223, such as a multiplexer, to simultaneously retrieve one data element from each data segment or the banks of a transpose unit.

In one embodiment, the method uses a shift register to convert the retrieved data elements into a serial data stream.

In one embodiment, the method uses an address generator to determine an address for the data.

In one embodiment, the method uses an address generator to determine an address for transferred data in the global memory.

The data structures and code described in this detailed description are typically stored on a non-transitory computer-readable storage medium, which may be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code stored within the non-transitory computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The above-described embodiments of the present invention are intended to be illustrative only. Those skilled in the art may devise numerous alternative embodiments without departing from the scope of the following claims.

What is claimed is:

1. An apparatus for transferring data, comprising:
a transpose unit comprising:
a plurality of banks each having a plurality of storage units;
a write circuit coupled with each bank and a source memory, configured to perform selections on the plurality of banks for storing data from the source memory;
a plurality of selectors corresponding to the plurality of banks, each selector comprising a plurality of inputs respectively coupled with the plurality of storage units of the corresponding bank and an output; and
a parallel-to-serial circuit coupled with the plurality of selectors and a destination memory, wherein the outputs of the plurality of selectors connect in parallel with the parallel-to-serial circuit.

2. The apparatus of claim 1, further comprising a control unit to control the write circuit to perform selections on the plurality of banks.

3. The apparatus of claim 1, further comprising a control unit and two transpose units, wherein the control unit is configured to select one of the two transpose units to transfer and transpose data from the source memory.

4. The apparatus of claim 1, further comprising a control unit and a first address generator coupled with the control unit, wherein the control unit controls the first address generator in order to generate an address of data to be transferred from the source memory.

5. The apparatus of claim 1, further comprising a control unit and a second address generator coupled with the control unit, wherein the control unit controls the second address generator to determine an address for data from the parallel-to-serial circuit to the destination memory.

6. The apparatus of claim 1, wherein the write circuit comprises a plurality of D flip-flops corresponding to the banks, a plurality of AND gates corresponding to the D flip-flops, and a decoder, wherein two inputs of each AND gate respectively connect to the decoder and a clock signal node, an output of the each AND gate connects to a clock input of the corresponding D flip-flop, a data input of each D flip-flop connects to the source memory, and an output of each D flip-flop connects to the corresponding bank.

7. The apparatus of claim 1, wherein each selector is a multiplexer.

8. The apparatus of claim 1, wherein the parallel-to-serial circuit comprises a plurality of D flip-flops corresponding to the selectors, wherein a data input of each D flip-flop connects to the output of the corresponding selector and an output of each D flip-flop connects to the destination memory.

9. A method for transferring data in a computer, comprising:
providing data in a source memory, wherein the data is formed by a plurality of data segments corresponding to each other and each data segment comprises a plurality of data elements;
simultaneously retrieving one data element from each data segment;
converting the retrieved data elements into a serial data stream; and
transferring the serial data stream to a destination memory.

10. The method of claim 9, wherein the retrieved data elements of the serial data stream have a same type.

11. The method of claim 9, further comprising providing at least one transpose unit comprising a plurality of banks and transferring the data elements of each data segment to the corresponding bank(s) of the at least one transpose unit.

12. The method of claim 9, further comprising providing a multiplexer to simultaneously retrieve one data element from each data segment.

13. The method of claim 9, further comprising providing a shift register to convert the retrieved data elements into a serial data stream.

14. The method of claim 9, further comprising providing an address generator to determine an address for the data.

15. The method of claim 9, further comprising providing an address generator to determine an address for transferred data in the destination memory.
